(19) United States
(12) Patent Application Publication
(10) Pub. No.: US 2026/0112684 A1
(43) Pub. Date: Apr. 23, 2026

(54) POSITIVE ELECTRODE ACTIVE MATERIAL FOR LITHIUM-ION SECONDARY BATTERY

(71) Applicant: TOYOTA JIDOSHA KABUSHIKI KAISHA, Toyota-shi (JP)

(72) Inventor: Ryosuke Ohsawa, Okazaki-shi (JP)

(73) Assignee: TOYOTA JIDOSHA KABUSHIKI KAISHA, Toyota-shi (JP)

(21) Appl. No.: 19/223,488

(22) Filed: May 30, 2025

(30) Foreign Application Priority Data
Oct. 22, 2024 (JP) 2024-186004

(51) Int. Cl. H01M 10/0525; H01M 4/02; H01M 4/505; H01M 4/525

(52) U.S. Cl. CPC H01M 10/0525; H01M 4/505; H01M 4/525; H01M 2004/021; H01M 2004/028

(57) ABSTRACT

The present disclosure relates to a positive electrode active material for a lithium-ion secondary battery. The positive electrode active material for a lithium-ion secondary battery according to the present disclosure contains secondary particles. The secondary particle includes three or more primary particles. The secondary particles are provided by two-dimensionally arranging three or more primary particles.

### CROSS-REFERENCE TO RELATED APPLICATION

This application claims priority to Japanese Patent Application No. 2024-186004 filed on Oct. 22, 2024. The disclosure of the above-identified application, including the specification, drawings, and claims, is incorporated by reference herein in its entirety.

### BACKGROUND

### 1. Technical Field

The present disclosure relates to a positive electrode active material for a lithium-ion secondary battery.

### 2. Description of Related Art

Japanese Unexamined Patent Application Publication No. 2023-036570 (JP 2023-036570 A) discloses a ternary positive electrode material that is a secondary particle having a spherical shape. In the secondary particle, primary particles are aggregated.

### SUMMARY

In general, a positive electrode active material for a lithium-ion secondary battery (hereinafter, may be abbreviated as “positive electrode active material”) has a secondary particle in which primary particles are aggregated. For example, by three-dimensionally arranging the primary particles, it is possible to provide the secondary particles having a spherical shape. Regarding the secondary particle in which the primary particles are three-dimensionally arranged, it is considered that an electrolyte is less likely to diffuse into the inside of the secondary particle. Therefore, there is a possibility that resistance increases during long-time discharge. That is, there is room for improvement in a rate characteristic.

An object of the present disclosure is to improve a rate characteristic.

A positive electrode active material for a lithium-ion secondary battery includes
a secondary particle.
The secondary particle includes three or more primary particles.
The three or more primary particles are two-dimensionally arranged to provide the secondary particle.

The secondary particle of the present disclosure has two-dimensional morphology. That is, the primary particles are two-dimensionally arranged. It is considered that a two-dimensional array is easier for an electrolyte to diffuse over an entirety of the secondary particle as compared with a three-dimensional array. Therefore, the improvement in the rate characteristic is expected.

The positive electrode active material for a lithium-ion secondary battery may include, for example, the following configuration.

The secondary particle includes three or more and 20 or less of the primary particles.

When the number of primary particles is 20 or less, the two-dimensional array tends to be stable.

The positive electrode active material for a lithium-ion secondary battery may include, for example, the following configuration.
The secondary particle has an in-plane direction and a thickness direction.
The in-plane direction is any direction orthogonal to the thickness direction.
The three or more primary particles are arranged in the in-plane direction.
A through-hole penetrating the secondary particle is provided along the thickness direction.

The through-hole communicates both surfaces of the secondary particle that is planar. It is expected that the diffusion of the electrolyte is promoted by the through-hole. The through-hole may be, for example, a gap between the primary particles.

The positive electrode active material for a lithium-ion secondary battery may include, for example, the following configuration.
A relationship of “1<b/a<5” is satisfied,
where “a” represents an opening diameter of the through-hole, and
“b” represents a Feret diameter of the primary particle in the thickness direction.

When the relationship of “1<b/a<5” is satisfied, the improvement in the rate characteristic is expected. When the relationship of “1<b/a” is satisfied, it is expected that the diffusion of the electrolyte is promoted. When the relationship of “b/a<5” is satisfied, the two-dimensional array tends to be stable.

The positive electrode active material for a lithium-ion secondary battery may include, for example, the following configuration.
The positive electrode active material for a lithium-ion secondary battery is a lithium nickel cobalt manganese composite oxide.

The positive electrode active material for a lithium-ion secondary battery may be a so-called ternary material.

Hereinafter, an embodiment of the present disclosure (hereinafter, may be abbreviated as “the present embodiment”) and an example of the present disclosure (hereinafter, may be abbreviated as “the present example”) will be described. Meanwhile, the present embodiment and the present example do not limit the technical scope of the present disclosure. The present embodiment and the present example are illustrative in all respects. The present embodiment and the present example are non-restrictive. The technical scope of the present disclosure includes all changes within the meaning and the scope that are equivalent to the description of claims. For example, extracting arbitrary configurations from the present embodiment and arbitrarily combining the configurations are preconceived from the first.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual view of secondary particles in the present embodiment;

FIG. 2 is a table showing experimental results; and

FIG. 3 is a conceptual diagram showing an example of a mixing device.

### DETAILED DESCRIPTION OF EMBODIMENTS

### Terms and Phrases

Geometrical terms should not be interpreted in a strict sense. Examples of the geometrical terms include “parallel”, “perpendicular”, and “orthogonal”. For example, the direction, the angle, and the distance may be relatively displaced within a range in which substantially the same or similar functions can be obtained. The geometrical term may include, for example, a tolerance and an error in design, operation, and manufacturing. The dimensional relationships in each of the drawings sometimes do not agree with the actual dimensional relationships. In order to facilitate understanding of the reader, the dimensional relationship in each of the drawings may be changed. For example, the length, the width, and the thickness may be changed. In some cases, a part of the configuration may be omitted.

“D50” indicates a particle size at which the cumulative frequency is 50% in the volume-based particle size distribution (cumulative distribution). The D50 can be measured, for example, by a laser diffraction method.

The “Feret diameter” indicates a distance between two straight lines that sandwich the particle with two parallel straight lines. For example, the Feret diameter in the thickness direction is measured by sandwiching the particle between two straight lines orthogonal to the thickness direction.

The “opening diameter” indicates the maximum Feret diameter of the opening portion of the through-hole. The maximum Feret diameter indicates a maximum value among the Feret diameters in the in-plane direction.

All numerical values are modified by the term “about”. The term “about” can mean, for example, ±5%, ±3%, and ±1%. All numerical values may be approximate values that may change depending on the usage form of the target technology. All numerical values can be expressed in significant figures. The measured value can be an average value in a plurality of measurements unless otherwise specified. The number of times of measurement may be three or more, five or more, or 10 or more. Generally, it is expected that the reliability of the average will be improved as the number of times of measurement increases. The measured value can be rounded off to the nearest integer based on number of digits of the significant figures. The measured value can include, for example, an error that occurs due to the detection limit of the measuring device.

The stoichiometric composition formula shows representative examples of the compounds. The compound may have a non-stoichiometric composition. For example, “Al₂O₃” is not limited to a compound having a mass ratio (molar ratio) of “Al/O=2/3”. Unless otherwise specified, “Al₂O₃” represents a compound containing Al and O at an optional molar ratio. For example, the compound may be doped with a trace element. a part of Al and O may be substituted with another element.

### Positive Electrode Active Material

The positive electrode active material is for a lithium-ion secondary battery. A lithium-ion secondary battery (hereinafter, may be abbreviated as “battery”) may be a liquid battery or an all-solid battery. In the all-solid-state battery, the rate characteristics are expected to be improved by improving the contact rate between the solid electrolyte and the primary particles, for example. The battery may have any structure. The battery may have, for example, a wound or stacked power generation element. The battery may have, for example, a unipolar structure or a bipolar structure.

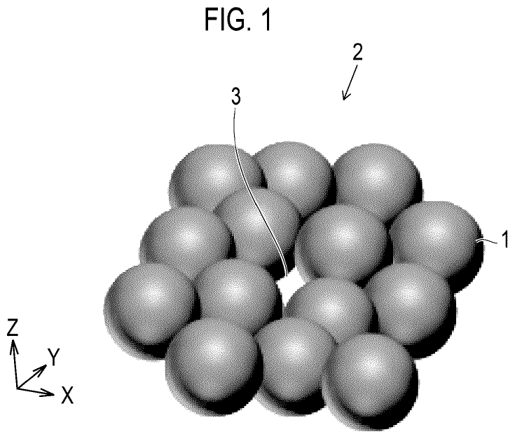

FIG. 1 is a conceptual view of secondary particles in the present embodiment. The positive electrode active material contains secondary particles 2. The positive electrode active material may include an aggregate (powder) of secondary particles 2. The D50 of the positive electrode active material may be, for example, 1 μm or more, 5 μm or more, 10 μm or more, 15 μm or more, or 20 μm or more. The D50 of the positive electrode active material may be, for example, 30 μm or less, 25 μm or less, 20 μm or less, 15 μm or less, or 10 μm or less.

The secondary particle 2 includes three or more primary particles 1. The number of the primary particles 1 may be, for example, four or more, six or more, eight or more, 10 or more, 12 or more, 14 or more, 16 or more, 18 or more, or 20 or more. The number of the primary particles 1 may be, for example, 25 or less, 23 or less, 21 or less, 19 or less, 17 or less, 15 or less, 13 or less, 11 or less, nine or less, seven or less, or five or less. The number of the primary particles 1 indicates the average number of the primary particles 1 in 10 randomly extracted secondary particles 2.

The primary particles 1 are arranged two-dimensionally. The secondary particle 2 (an aggregate of the primary particles 1) viewed from a macroscopic viewpoint has a so-called platelet shape. The appearance of the secondary particle 2 may be planar or may be curved. A direction in a plane or a curved surface is an “in-plane direction”. The X-axis direction and the Y-axis direction in FIG. 1 are examples of the in-plane direction. A direction orthogonal to the in-plane direction is an “out-of-plane direction”. The out-of-plane direction is also the thickness direction of the secondary particle 2. The Z-axis direction in FIG. 1 is an out-of-plane direction (thickness direction). Therefore, the in-plane direction may be expressed as any direction orthogonal to the thickness direction. For example, in a case where there is no primary particle 1 overlapping in the out-of-plane direction, the array of the primary particles is considered to be “two-dimensional”. For example, in a case where there is the primary particle 1 overlapping in the out-of-plane direction, the array of the primary particles is considered to be “three-dimensional”. For example, in a case where the primary particles 1 are linearly connected, the array of the primary particles 1 is considered to be “one-dimensional”. The array and the number of the primary particles 1 can be specified by, for example, at least one of a three-dimensional scanning electron microscope (SEM) observation method and a cross-sectional SEM observation method. It is expected that the rate characteristics are improved by the fact that the array of the primary particles 1 is two-dimensional.

The primary particle 1 has an arbitrary shape. The primary particles 1 may be, for example, an ellipsoidal shape, a flake shape, a platelet shape, a rod shape, or a columnar shape. The primary particle 1 may have a short axis and a long axis. The short axis length is a length of a short side of a minimum bounding rectangle (MBR) of the primary particle 1 in the SEM image of the primary particle 1. The major axis length indicates the length of the long side of the MBR. The short axis direction indicates a direction parallel to the short axis. The longitudinal axis direction indicates a direction parallel to the major axis. The primary particles 1 may be arranged such that the short axis direction is along the thickness direction (Z-axis direction). The angle between the short axis direction and the thickness direction may be, for example, 30° or less, 15° or less, 7.5° or less, or 3° or less. The angle between the short axis direction and the thickness direction may be, for example, 0° or more, 3° or more, or 7.5° or more. For example, the short axis direction of the primary particle 1 may be parallel to the thickness direction of the secondary particle 2. When the short axis direction is parallel to the thickness direction, the Feret diameter of the primary particle 1 in the thickness direction is considered to be equal to the short axis diameter.

The Feret diameter “b” of the primary particles in the thickness direction may be, for example, 1.6 μm or more, 2.0 μm or more, 2.4 μm or more, 2.8 μm or more, 3.2 μm or more, 3.6 μm or more, 4.0 μm or more, 4.4 μm or more, 4.8 μm or more, or 5.2 μm or more. The Feret diameter “b” of the primary particles in the thickness direction may be, for example, 5.3 μm or less, 5.1 μm or less, 4.9 μm or less, 4.7 μm or less, 4.5 μm or less, 4.3 μm or less, 4.1 μm or less, 3.9 μm or less, 3.7 μm or less, 3.5 μm or less, 3.3 μm or less, 3.1 μm or less, 2.9 μm or less, 2.7 μm or less, 2.5 μm or less, 2.3 μm or less, 2.1 μm or less, 1.9 μm or less, or 1.7 μm or less.

The aspect ratio indicates a ratio of the major axis to the minor axis. The aspect ratio of the primary particles 1 may be, for example, 1 or more, 1.2 or more, 1.4 or more, 1.6 or more, 1.8 or more, or 2 or more. The aspect ratio of the primary particles 1 may be, for example, 5 or less, 4 or less, 3 or less, 2 or less, or 1.5 or less. The short axis and the long axis indicate average values in 10 primary particles.

The secondary particle 2 may be provided with a through-hole 3. The through-holes 3 may penetrate the secondary particles 2 in the thickness direction (Z-axis direction). Since the through-holes 3 communicate with the surface of the secondary particles 2, the improvement of the rate characteristics is expected. For example, in the secondary particle in which the primary particles 1 are three-dimensionally arranged, it is considered that the pores are easily provided in a long and complicated path. On the other hand, in the secondary particle 2 in which the primary particles 1 are two-dimensionally arranged, it is considered that the through-holes easily provides a short and simple path. It is expected that the diffusion of the electrolyte is promoted by providing the through-holes to provide a short and simple path.

A single through-hole 3 may be provided in the secondary particle 2, or a plurality of through-holes 3 may be provided in the secondary particle 2. The number of the through-holes 3 may be, for example, one or more, three or more, five or more, or seven or more. The number of the through-holes 3 may be, for example, 10 or less, eight or less, six or less, four or less, or two or less. For example, the number of the through-holes 3 may be equal to or less than half the number of the primary particles 1. The number of through-holes 3 indicates an average value in the 10 secondary particles 2.

The through-holes 3 may be, for example, gaps between the primary particles 1. The opening diameter “a” of the through-hole 3 may be, for example, equal to or smaller than the long axis diameter of the primary particle 1, 0.8 times or smaller, 0.5 times or smaller, or 0.2 times or smaller. The opening diameter “a” may be, for example, 0.1 times or more the major axis diameter of the primary particle 1. The opening diameter “a” may be, for example, 0.1 μm or more, 0.3 μm or more, 0.5 μm or more, 0.7 μm or more, 0.9 μm or more, 1.1 μm or more, 1.3 μm or more, 1.5 μm or more, or 1.7 μm or more. The opening diameter “a” may be, for example, 1.8 μm or less, 1.6 μm or less, 1.4 μm or less, 1.2 μm or less, 1.0 μm or less, 0.8 μm or less, 0.6 μm or less, 0.4 μm or less, or 0.2 μm or less.

The ratio “b/a” of the Feret diameter “b” of the primary particle in the thickness direction to the opening diameter “a” may affect the rate characteristics or the like. The ratio of “b/a” may be, for example, 1.1 or more, 1.3 or more, 1.5 or more, 1.7 or more, 1.9 or more, 2.1 or more, 2.3 or more, 2.5 or more, 2.7 or more, 2.9 or more, 3.1 or more, 3.3 or more, 3.5 or more, 3.7 or more, 3.9 or more, 4.1 or more, 4.3 or more, 4.5 or more, 4.7 or more, 4.9 or more, 5.1 or more, 5.3 or more, 5.5 or more, or 5.7 or more. For example, it is expected that the diffusion of the electrolyte is promoted by satisfying the relationship of “1<b/a”. The ratio of “b/a” may be, for example, 5.8 or less, 5.6 or less, 5.4 or less, 5.2 or less, 5.0 or less, 4.8 or less, 4.6 or less, 4.4 or less, 4.2 or less, 4.0 or less, 3.8 or less, 3.6 or less, 3.4 or less, 3.2 or less, 3.0 or less, 2.8 or less, 2.6 or less, 2.4 or less, 2.2 or less, 2.0 or less, 1.8 or less, 1.6 or less, 1.4 or less, or 1.2 or less. For example, when the relationship of “b/a<5” is satisfied, the two-dimensional array tends to be stable. For example, the relationship of “1<b/a<5” may be satisfied. For example, the relationship of “1.5≤b/a≤3.8” may be satisfied. The Feret diameter “b” of the primary particles in the thickness direction is considered to be equal to the path length of the through-hole 3.

The secondary particle 2 has a flat shape. The secondary particle 2 may have a short axis and a long axis. The short axis diameter of the secondary particle 2 indicates the Feret diameter in the thickness direction. The major axis diameter of the secondary particle 2 indicates the maximum Feret diameter in the in-plane direction. In the secondary particle 2, the ratio of the major axis length to the minor axis length may be, for example, 1 or more, 2 or more, 3 or more, 4 or more, or 5 or more. In the secondary particle 2, the ratio of the major axis to the minor axis may be, for example, 10 or less, 8 or less, 6 or less, or 5 or less.

The positive electrode active material may have any chemical composition. The positive electrode active material may have, for example, a crystal structure belonging to the space group R-3m. The space group is identified by a powder X-ray diffraction (XRD) measurement. The positive electrode active material may include, for example, at least one selected from the group consisting of lithium nickel composite oxide, lithium nickel cobalt manganese composite oxide, and lithium nickel cobalt aluminum composite oxide. The positive electrode active material may have a composition represented by, for example, a general formula “LiₓNiₐCo_{b}Mn_{c}O_{y}”. In the general formula, for example, the relationship of “0.1≤x≤1.5”, “0.5≤a≤1.0”, “0≤b≤0.3”, “0≤c≤0.3”, “a+b+c=1.0”, and “1.5≤y ≤2.1” may be satisfied. In the general formula, for example, a relationship of “0.9≤x≤1.1”, “0.7≤a≤0.9”, “0.05≤b≤0.15”, or “0.05≤c≤0.15” may be satisfied. Any dopant may be added to the positive electrode active material.

The positive electrode active material (powder) may be provided by “secondary particles 2 provided by the two-dimensional array of primary particles 1”. The positive electrode active material may further include, for example, “secondary particles provided by a one-dimensional array of primary particles”, or “secondary particles provided by a three-dimensional array of primary particles”, in addition to “secondary particles 2 provided by a two-dimensional array of primary particles 1”. The number proportion of the “secondary particles 2 constituted by the two-dimensional array of the primary particles 1” in the positive electrode active material may be, for example, 5% or more, 10% or more, 25% or more, 75% or more, or 90% or more.

### Synthesis Method

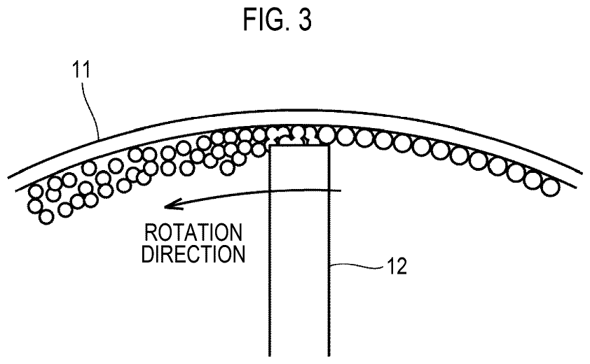

The two-dimensional morphology can be realized by performing granulation under high shear force and centrifugal force. A precursor (metal hydroxide) is prepared, for example, by a coprecipitation method. The metal hydroxide may have a composition represented by, for example, a general formula “NiₐCo_{b}Mn_{c}OH”. For example, the precursor and LiOH may be mixed by a mechanofusion system. FIG. 3 is a conceptual diagram showing an example of a mixing device. In the cylindrical container 11, the particles are compressed, sheared, and impacted by the rotation of the rotor 12, while being interposed between the inner wall of the container 11 and the rotor 12. For example, by adjusting the gap between the container 11 and the rotor 12 to the level of the primary particle size, flat primary particles and flat secondary particles can be provided. In the secondary particle, the primary particles can be two-dimensionally arranged. The number of primary particles may be adjusted, for example, by the rotation speed of the rotor, or the processing time. By firing the flat secondary particles, a positive electrode active material can be produced.

### Sample Preparation

### No. 1

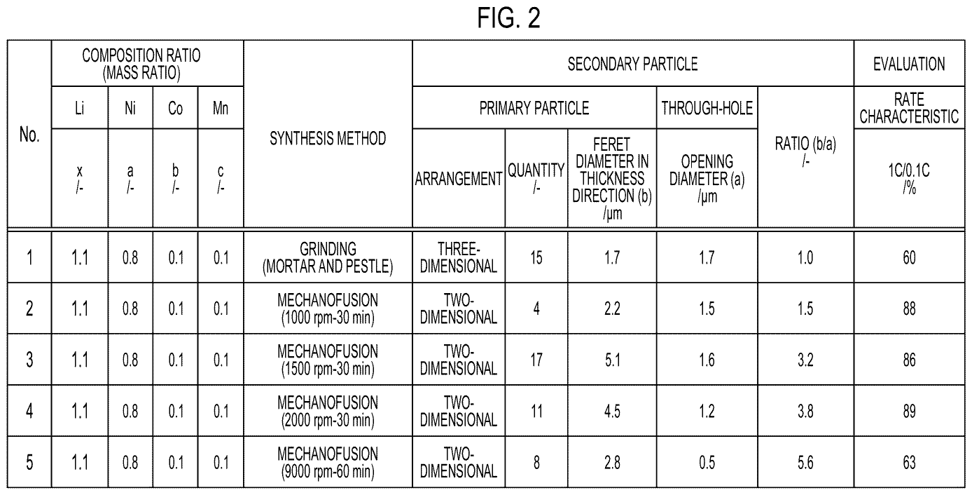

FIG. 2 is a table showing the experimental results. The raw material solution was provided by dissolving NiSO₄, CoSO₄, and MnSO₄ in ion-exchange water. In the raw material solution, the molar ratio of Ni, Co, and Mn was “Ni/Co/Mn=8/1/1”. The solute concentration in the raw material solution was 30% (mass fraction).

Ammonium hydroxide was charged into the reaction vessel. The reaction vessel was substituted with nitrogen while the ammonia water was stirred with a stirrer. Further, NaOH was put into the reaction vessel, whereby an alkaline reaction solution was provided.

The raw material solution and the aqueous ammonia were dropped into the reaction solution such that the reaction solution maintained a pH in a certain range, whereby a precipitate (metal hydroxide) was provided. The reaction solution was filtered to recover the metal hydroxide. The metal hydroxide was dispersed in ion-exchanged water to provide a dispersion liquid. The dispersion liquid was sufficiently stirred with a spatula. That is, the metal hydroxide was washed with water. After washing, the dispersion liquid was filtered to recover the metal hydroxide. The metal hydroxide was dried at 120° C. for 16 hours to provide a dry matter.

In a mortar, a mixture was provided by mixing a dry matter (metal hydroxide) and a lithium compound (LiOH, Li₂CO₃) with a pestle. The ratio of the mass of Li to the mass of the metal hydroxide was 1.1.

In the muffle furnace, the mixture was heat-treated to synthesize the positive electrode active material. The conditions of the heat treatment (firing) were as follows.

After the heat treatment, the particle size of the positive electrode active material was adjusted by a jet mill.
Atmosphere: Oxygen atmosphere
Temperature: 700° C. to 1,100° C.
Time: 10 hours

### No. 2

In the same manner as in No. 1, a dry matter (metal hydroxide) was prepared by the coprecipitation method. The NOBILTA (a registered trademark) MINI was prepared as a mixing device. The mixing device has an internal structure of FIG. 3. The dry matter and the lithium compound (LiOH, Li₂CO₃) were mixed by the same mixing device to provide a mixture. The ratio of the mass of Li to the mass of the metal hydroxide was 1.1. In the item of the synthesis method of FIG. 2, for example, the description of “1000 rpm-30 min” indicates that the rotation speed of the rotor in the mixing device is 1000 rpm and the processing time is 30 minutes. After the mixture is provided, the mixture was fired and pulverized in the same manner as in No. 1 to produce a positive electrode active material.

### No. 3 to No. 5

As shown in the item of the synthesis method of FIG. 2, the positive electrode active material was manufactured in the same manner as in No. 2 except that the rotation speed and the processing time of the rotor were changed.

### Evaluation

A cylindrical lithium-ion secondary battery (evaluation cell) was manufactured. The configuration of the evaluation cell is as follows.

Power generation element: wound type Positive electrode: Positive electrode active material/AB/PVDF=88/10/2 (mass ratio) Negative electrode: negative electrode active material (natural graphite), CMC, SBR Electrolyte: LiPF₆ (1 mol/L), EC/DMC/EMC=3/4/3 (volume ratio)

The positive electrode and the negative electrode were manufactured by coating the surface of a base material (metal foil) with a slurry. As the coating device, a film applicator (with a film thickness adjusting function) manufactured by ALL GOOD Co., Ltd. was used. After the slurry was coated, the coating film was dried at 80° C. for 5 minutes.

A discharge capacity “Cp_{0.1}” was measured by a constant current (CC) discharge of 0.1 C. Further, by the CC discharge of 1 C, the discharge capacity “Cp₁” was measured. In a rate of 0.1 C, the rated capacity of the cell is flowed for 10 hours. The rate of 1 C is 10 times the rate of 0.1 C. The discharge capacity “Cp₁” was divided by the discharge capacity “Cp_{0.1}” to calculate the discharge capacity ratio “1 C/0.1 C”. It is considered that the rate characteristics are better as the ratio of the discharge capacity “1 C/0.1 C” is larger.

### Result

In the secondary particles of No. 1, the primary particles were three-dimensionally arranged. In the secondary particles of No. 2 to No. 5, the primary particles were two-dimensionally arranged. The rate characteristics tend to be improved by two-dimensionally arranging of the primary particles.

The rate characteristics tend to be improved by satisfying the relationship of “1<b/a<5” between the opening diameter of the through-hole and the Feret diameter of the primary particle in the thickness direction.

What is claimed is:

1. A positive electrode active material for a lithium-ion secondary battery, the positive electrode active material comprising a secondary particle, wherein:
the secondary particle includes three or more primary particles; and
the three or more primary particles are two-dimensionally arranged to provide the secondary particle.

2. The positive electrode active material according to claim 1, wherein the secondary particle includes three or more and 20 or less of the primary particles.

3. The positive electrode active material according to claim 1, wherein:
the secondary particle has an in-plane direction and a thickness direction;
the in-plane direction is any direction orthogonal to the thickness direction;
the three or more primary particles are arranged in the in-plane direction; and
a through-hole penetrating the secondary particle is provided along the thickness direction.

4. The positive electrode active material according to claim 3, wherein a relationship of 1<b/a<5 is satisfied,
where a represents an opening diameter of the through-hole, and
b represents a Feret diameter of the primary particle in the thickness direction.

5. The positive electrode active material according to claim 1, wherein the positive electrode active material is a lithium nickel cobalt manganese composite oxide.
